(19) United States
(12) Patent Application Publication
(10) Pub. No.: US 2008/0163132 A1
(43) Pub. Date: Jul. 3, 2008

(54) STREAMLINED NAVIGATION OF A HANDHELD ELECRONIC DEVICE

(76) Inventors: Matthew Richard Lee, Belleville (CA); Piotr Konrad Tysowski, Waterloo (CA)

Correspondence Address: NOVAK DRUCE + QUIGG LLP (RIM), 1000 LOUISIANA STREET, FIFTY-THIRD FLOOR, HOUSTON, TX, 77002, US

(21) Appl. No.: 11/617,928

(22) Filed: Dec. 29, 2006

(51) Int. Cl. G06F 3/00

(52) U.S. Cl. 715/864

(57) ABSTRACT

A system and method is disclosed that provides for progressively displaying sequential pages on a handheld electronic device for user viewing. The system and method provides for displaying a first page of a plurality of sequentially linked pages on a display screen of a handheld electronic device, and displaying two navigation icons on the display screen of the handheld electronic device together with the first page, one of said two navigation icons signifying the previous page to the first page and acting as a user-actuable link thereto when a previous page exists and the other of said two navigation icons signifying the next page to the first page and acting as a user-actuable link thereto when a next page exists. The system and method further provide for scrolling toward a bottom of the first page until a lower boundary of the first page is reached and upon reaching said lower boundary, the navigation icon signifying the next page being automatically designated for user actuation.

A portion of the disclosure of this patent document contains material which is subject to copyright protection. The copyright owner has no objection to the facsimile reproduction by any one of the patent document or patent disclosure as it appears in the Patent and Trademark Office patent file or records, but otherwise reserves all copyright rights whatsoever.

### FIELD

The present disclosure, in a broad sense, is directed toward handheld electronic devices including those without communication capabilities such as Personal Digital Assistants (PDAs), and more specifically the disclosure is directed toward handheld communication devices that have wireless communication capabilities and the networks within which the wireless communication devices operate. More particularly, the instant disclosure relates to facilitating navigation among pages displayed on a handheld electronic device.

### BACKGROUND

With the advent of more robust wireless communications systems, compatible handheld communication devices are becoming more prevalent, as well as advanced. Where in the past such handheld communication devices typically accommodated either voice transmission (cell phones) or text transmission (pagers and PDAs), today's consumer often demands a combination device capable of performing both types of transmissions, including even sending and receiving e-mail. Furthermore, these higher-performance devices can also be capable of sending and receiving other types of data including that which allows the viewing and use of Internet websites. These higher level functionalities necessarily require greater user interaction with the devices through included user interfaces (UIs) which may have originally been designed to accommodate making and receiving telephone calls and sending messages over a related Short Messaging Service (SMS). As might be expected, suppliers of such mobile communication devices and the related service providers are anxious to meet these customer requirements, but the demands of these more advanced functionalities have in many circumstances rendered the traditional user interfaces unsatisfactory, a situation that has caused designers to have to improve the UIs through which users input information and control these sophisticated operations.

### BRIEF DESCRIPTION OF THE DRAWINGS

Exemplary methods and arrangements conducted and configured according to the advantageous solutions presented herein are depicted in the accompanying drawings wherein:

FIG. 1 depicts a handheld communication device cradled in the palm of a user's hand;

FIG. 2 depicts a handheld communication device displaying the top of a digital page with navigational icons;

FIG. 3 depicts a handheld communication device displaying the bottom of a digital page with navigational icons;

FIG. 4 depicts a handheld communication device displaying a page with navigational icons and the navigational icon “Next” highlighted;

FIG. 5 illustrates an exemplary QWERTY keyboard layout;

FIG. 6 illustrates an exemplary QWERTZ keyboard layout;

FIG. 7 illustrates an exemplary AZERTY keyboard layout;

FIG. 8 illustrates an exemplary Dvorak keyboard layout;

FIG. 9 illustrates a QWERTY keyboard layout paired with a traditional ten-key keyboard;

FIG. 10 illustrates ten digits comprising the numerals 0-9 arranged in a telephone keypad configuration, including the * and # flanking the zero;

FIG. 11 illustrates a numeric phone key arrangement according to the ITU Standard E.161 including both numerals and letters;

FIG. 12 is a front view of an exemplary handheld electronic device including a full QWERTY keyboard;

FIG. 13 is a front view of another exemplary handheld electronic device including a full QWERTY keyboard;

FIG. 14 is a detail view of the reduced QWERTY keyboard;

FIG. 15 is a detail view of an alternative reduced QWERTY keyboard; and

FIG. 16 is a block diagram representing a wireless handheld communication device interacting in a communication network;

FIG. 17 is a block diagram representing a method in accordance with the present technology.

### DETAILED DESCRIPTION

As intimated hereinabove, one of the more important aspects of the handheld electronic device to which this disclosure is directed is its size. While some users will grasp the device in both hands, it is intended that a predominance of users will cradle the device in one hand in such a manner that input and control over the device can be affected using the thumb of the same hand in which the device is held, however additional control can be effected by using both hands. As a handheld device that is desirably pocketable, the size of the device must be kept relatively small. Of the device's dimensions, limiting its width is important for the purpose of assuring cradleability in a user's hand. Moreover, it is preferred that the width of the device be maintained at less than ten centimeters (approximately four inches). Keeping the device within these dimensional limits provides a hand cradleable unit that users prefer for its useability and portability. Limitations with respect to the height (length) of the device are less stringent when considering hand-cradleability. Therefore, in order to gain greater size, the device can be advantageously configured so that its height is greater than its width, but still remain easily supported and operated in one hand.

A potential problem is presented by the small size of the device in that there is limited exterior surface area for the inclusion of user input and device output features. This is especially true for the “prime real estate” on the front face of the device, where it is most advantageous to include a display screen that outputs information to the user. The display screen is preferably located above a keyboard that is utilized for data entry into the device by the user. If the screen is provided below the keyboard, a problem occurs in that viewing the screen is inhibited when the user is inputting data using the keyboard. Therefore it is preferred that the display screen be above the input area, thereby solving the problem by assuring that the hands and fingers do not block the view of the screen during data entry periods.

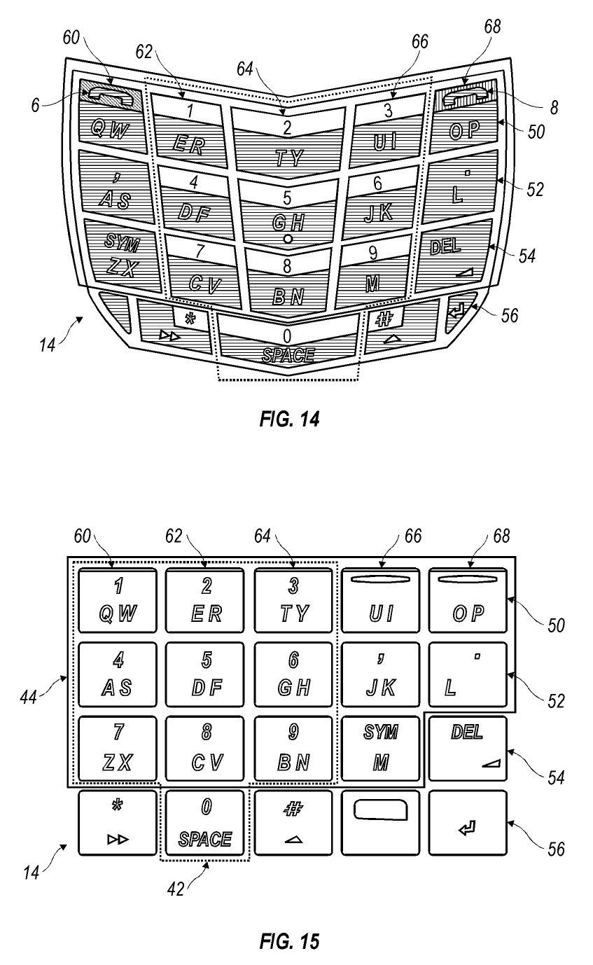

To facilitate textual data entry, an alphabetic keyboard is provided. In one version, a full alphabetic keyboard is utilized in which there is one key per letter (see FIG. 13 for an example). This is preferred by some users because it can be arranged to resemble a standard keyboard with which they are most familiar. In this regard, the associated letters can be advantageously organized in QWERTY, QWERTZ, AZERTY or Dvorak layouts, among others, thereby capitalizing on certain users′ familiarity with these special letter orders. In order to stay within the bounds of a limited front surface area, however, each of the keys must be commensurately small when, for example, twenty-six keys must be provided in the instance of the English language. An alternative configuration is to provide a reduced keyboard in which at least some of the keys have more than one letter associated therewith (see FIG. 14 for an example). This means that fewer keys are required which makes it possible for those fewer keys to each be larger than in the instance when a full keyboard is provided on a similarly dimensioned device. Some users will prefer the solution of the larger keys over the smaller ones, but it is necessary that software or hardware solutions be provided in order to discriminate which of the several associated letters the user intends based on a particular key actuation, a problem the full keyboard avoids. Preferably, this character discrimination is accomplished utilizing disambiguation software included on the device. To accommodate software use on the device, a memory and microprocessor are provided within the body of the handheld unit for receiving, storing, processing, and outputting data during use. Therefore, the problem of needing a textual data input means is solved by the provision of either a full or reduced alphabetic keyboard on the presently disclosed handheld electronic device. It should be further appreciated that the keyboard can be alternatively provided on a touch sensitive screen in either a reduced or full format.

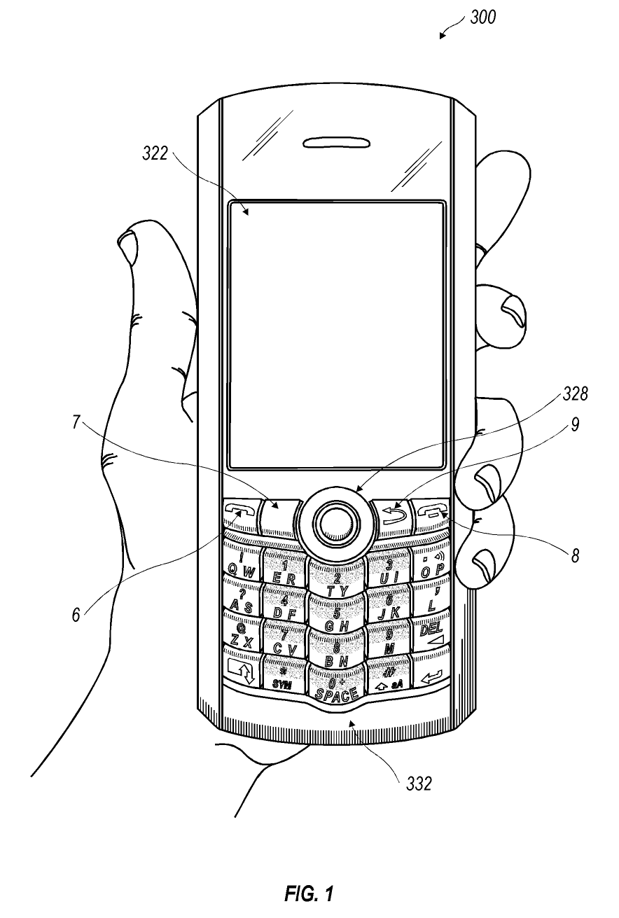

Keys, typically of a push-button or touchpad nature, perform well as data entry devices but present problems to the user when they must also be used to affect navigational control over a screen-cursor. In order to solve this problem, the present handheld electronic device preferably includes an auxiliary input that acts as a cursor navigational tool and which is also exteriorly located upon the front face of the device. Its front face location is particularly advantageous because it makes the tool easily thumb-actuable like the keys of the keyboard. In a particularly useful embodiment, the navigational tool is a trackball which is easily utilized to instruct two-dimensional screen cursor movement in substantially any direction, as well as act as an actuator when the ball of the trackball is depressed like a button. The placement of the trackball is preferably above the keyboard and below the display screen; here, it avoids interference during keyboarding and does not block the user's view of the display screen during use (see FIG. 1 for an example).

In some configurations, the handheld electronic device may be standalone in that it does not connect to the “outside world.” One example would be a PDA that stores such things as calendars and contact information but is not capable of synchronizing or communicating with other devices. In most situations such isolation will be viewed detrimentally in that synchronization is a highly desired characteristic of handheld devices today. Moreover, the utility of the device is significantly enhanced when connectable within a system, and particularly when connectable on a wireless basis in a network in which voice, text messaging, and other data transfer are accommodated.

As shown in FIG. 1, the handheld device 300 is cradleable in the palm of a user's hand. The handheld device is provided with a keyboard 332 to enter text data and place telephone calls and a display screen 322 for communicating information to the user. A connect/send key 6 is preferably provided to aid in the placement of a phone call. Additionally, a disconnect/end key 8 is provided. The send key 6 and end key 8 preferably are arranged in a row of keys including a navigation tool 328. Additionally, the row of keys including the navigation tool preferably has a menu key 7 and an escape key 9. The menu key 7 is used to bring up a menu and the escape key 9 is used to return to the previous screen or previous menu selection.

Because input commands are so common when navigating through screens, menus, applications and features thereof, users prefer to navigate electronic devices in an efficient manner. Commonly, devices present navigational icons on a display screen that allow the user to efficiently navigate between multiple pages of information. Navigation icons generally relate to directional functions, and present the user with an actuable link to move back, or continue forward between pages of linked information. Navigation icons also include icons that would allow the user to skip multiple pages at one time, to close an application, or to move onto a different application. A common example of navigation icons are those presented in internet browser programs which generally have “Back”, “Forward”, and “Home” navigation icons.

Navigation icons can be employed in various situations where it is useful to navigate multiple pages of information. Applications may present a user with multiple pages of information and request that the user review the displayed information. At times, the information presented on one page cannot be viewed in its entirety on the display screen and requires the user to scroll down the screen to view all the information presented. Upon viewing the information of a currently presented page, a user may wish to leave the page and could select a navigation icon to do so.

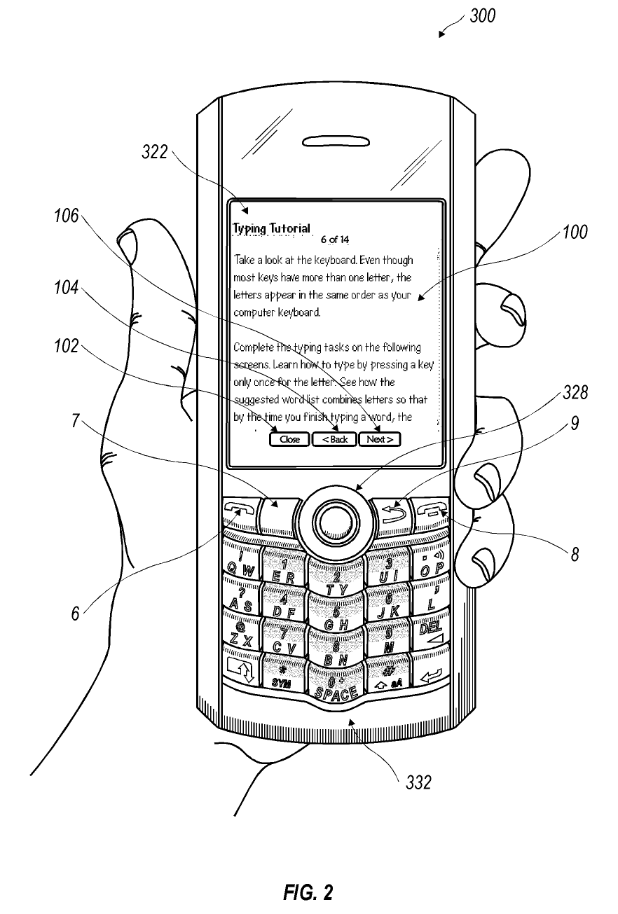

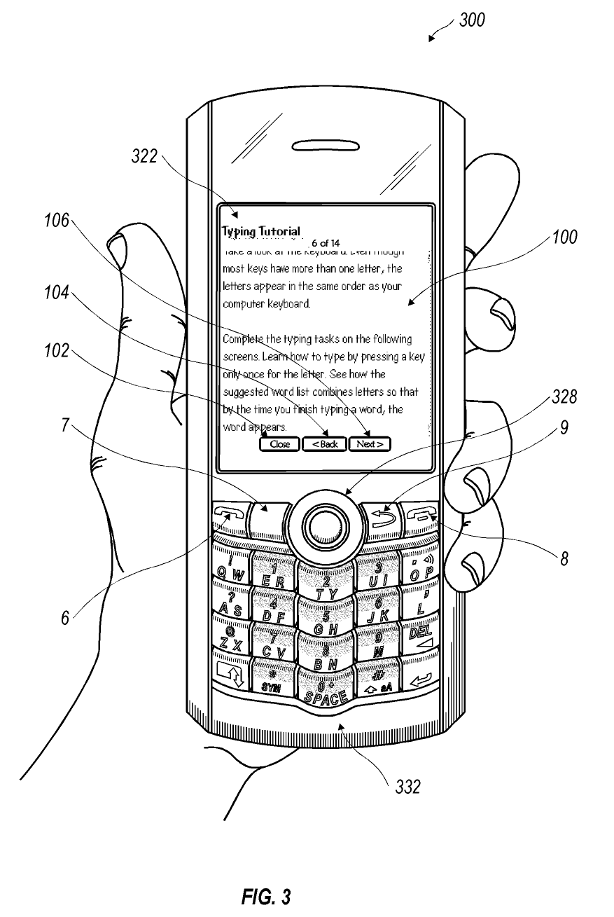

As seen in FIGS. 2, 3 and 4 a page 100 of text and navigation icons 102, 104, and 106 are presented on display screen 322. In this example, as seen in FIG. 2, the text cannot be presented in its entirety on display screen 322, and requires the user to scroll down the page to view additional text. Scrolling is the act of sliding a horizontal or vertical presentation of content, such as text, drawings, or images, across a screen or display window. Scrolling is generally accomplished in response to a user request. For example, a user may request to scroll down by actuating navigation tool 328 in a downward motion. FIG. 3 represents page 100 after a user has scrolled to the bottom of page 100 to reveal the previously non-displayed text.

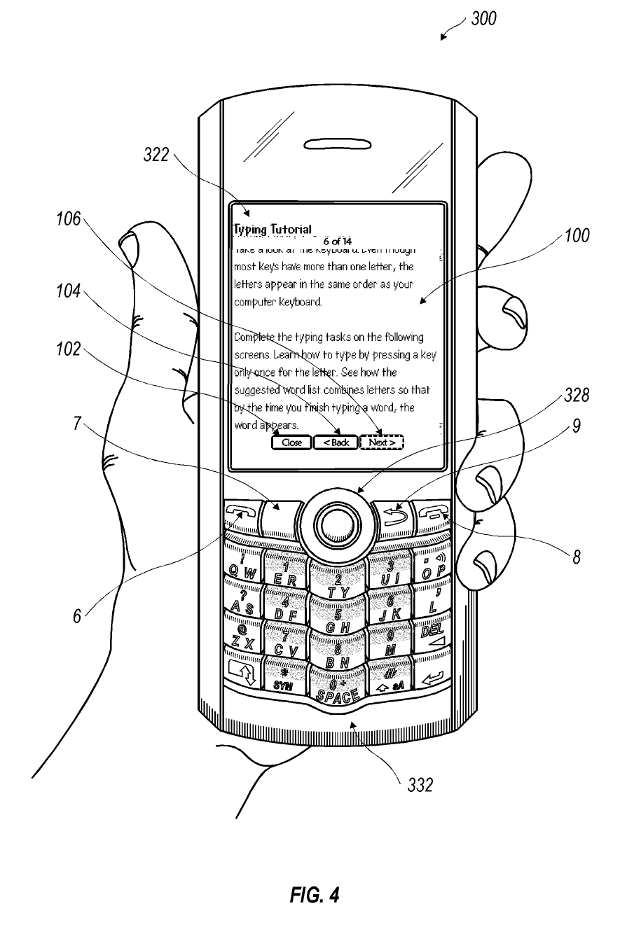

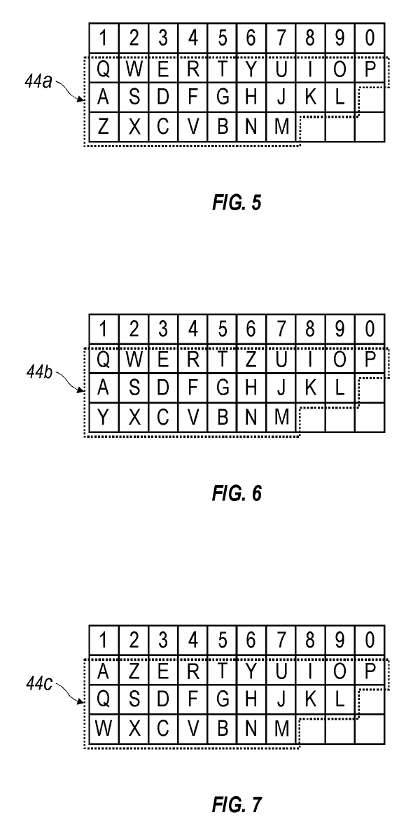

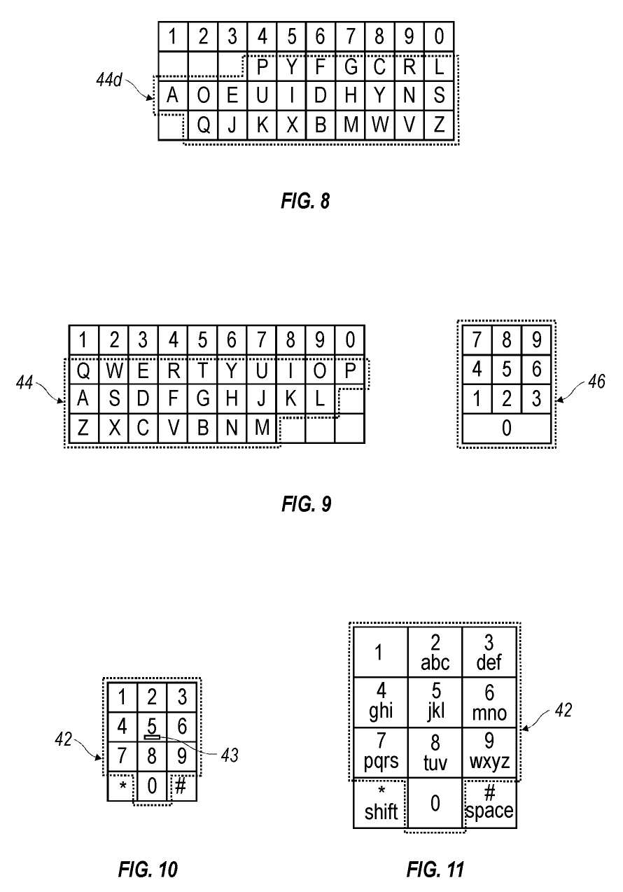

As seen in FIGS. 3 and 4, once the user has reached the end of the information on page 100, the user can continue to request that the page scroll down, and in doing so, the user reaches the lower boundary of page 100, which causes the automatic designation of a navigation icon (see navigation icon 106 in FIG. 4). FIG. 4 represents page 100 after a user continued scrolling after reaching the end of the information on page 100. In FIG. 4, navigation icon 106 was automatically designated. After the automatic designation of a navigation icon, the user may manually scroll between any navigation icons presented. As seen in FIG. 4 the user could manually designate between navigation icons 102, 104, and 106 after the first automatic designation takes place. It is preferred that when a user reaches the lower boundary of a page, and a navigation icon is designated, the icon which will be most commonly selected by users is automatically designated. Automatically designating the navigation icon that will be most commonly selected by users is the most logical step, and creates an efficient manner in which to progressively navigate sequential pages presented on a display screen. For example, if a user is navigating forward through sequential pages or completing sequential steps (e.g. step 6 of 14 is shown in FIGS. 2, 3 and 4), each time the user scrolls to the lower boundary of a given page to designate a navigation icon, the “Next” navigation icon will be automatically designated first. In another example, if the user is reading a final page, or completing a final step, the page can include a “Finish” navigation icon that would be automatically designated and could be further be activated to exit the pages or complete a series of steps.

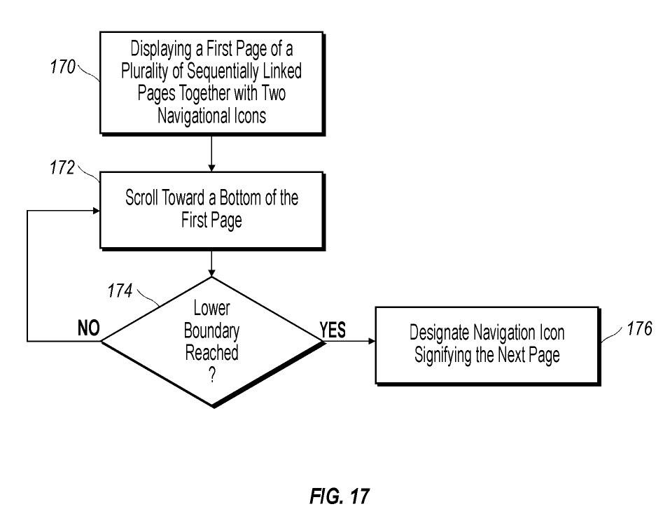

Referring to FIG. 17, a method in accordance with the present technology is graphically represented. The method includes displaying a first page of a plurality of sequentially linked pages together with two navigation icons (see step 170 in FIG. 17). One of the navigation icons acts as a user-actuable link signifying a previous page (if one exists) and the second navigation icon acts as a user-actuable link signifying a next page (if one exists). Navigation icons can be designated by scrolling 172 toward the bottom of the displayed page until a lower boundary is reached 174, whereupon the navigation icon signifying a next page would be automatically designated 176.

In another embodiment of the present technology, a processing subsystem is configured to be installed on the handheld electronic device. The processing subsystem includes operating system software that is programmed to control the operation of the handheld electronic device. The operating system is also configured to progressively display sequential pages on a handheld electronic device for user viewing. The operating system can display a first page of a plurality of sequentially linked pages on the display screen of the handheld electronic device. The operating system can also display two navigation icons together with the first page. The navigation icons act as user-actuable links to sequentially linked pages. One of the two navigation icons displayed can signify a previous page to the first page and the other navigation icon can signify a next page to the first page. The navigation icon signifying the next page to be displayed can be automatically designated by scrolling toward the bottom of the first page until a lower boundary of the first page is reached.

Further aspects of the environments, devices and methods of employment described hereinabove are expanded upon in the following details. An exemplary embodiment of the handheld electronic device 300 as shown in FIG. 1 is cradleable in the palm of a user's hand. The size of the device is such that a user is capable of operating the device 300 using the same hand that is holding the device 300. In a preferred embodiment, the user is capable of actuating all features of the device 300 using the thumb of the cradling hand; however, in other embodiments features may require the use of more than just the thumb of the cradling hand. The preferred embodiment of the handheld device 300 features a keyboard on the face of the device 300, which is actuable by the thumb of the hand cradling the device 300. The user may also hold the device 300 in such a manner to enable two thumb typing on the device 300.

The handheld electronic device 300 includes an input portion and an output display portion. The output display portion can be a display screen 322, such as an LCD or other similar display device.

The input portion includes a plurality of keys that can be of a physical nature such as actuable buttons or they can be of a software nature, typically constituted by virtual representations of physical keys on a display screen (referred to herein as “software keys”). It is also contemplated that the user input can be provided as a combination of the two types of keys. Each key of the plurality of keys has at least one actuable action which can be the input of a character, a command or a function. In this context, “characters” are contemplated to exemplarily include alphabetic letters, language symbols, numbers, punctuation, insignias, icons, pictures, and even a blank space. Input commands and functions can include such things as delete, backspace, moving a cursor up, down, left or right, initiating an arithmetic function or command, initiating a command or function specific to an application program or feature in use, initiating a command or function programmed by the user and other such commands and functions that are well known to those persons skilled in the art. Specific keys or other types of input devices can be used to navigate through the various applications and features thereof Further, depending on the application or feature in use, specific keys can be enabled or disabled.

In the case of physical keys, all or a portion of the plurality of keys have one or more indicia, representing character(s), command(s), and/or functions(s), displayed at their top surface and/or on the surface of the area adjacent the respective key. In the instance where the indicia of a key's function is provided adjacent the key, the indicia can be printed on the device cover beside the key, or in the instance of keys located adjacent the display screen 322. Additionally, current indicia for the key may be temporarily shown nearby the key on the screen 322.

In the case of software keys, the indicia for the respective keys are shown on the display screen 322, which in one embodiment is enabled by touching the display screen 322, for example, with a stylus to generate the character or activate the indicated command or function. Some examples of display screens 322 capable of detecting a touch include resistive, capacitive, projected capacitive, infrared and surface acoustic wave (SAW) touchscreens.

Physical and software keys can be combined in many different ways as appreciated by those skilled in the art. In one embodiment, physical and software keys are combined such that the plurality of enabled keys for a particular application or feature of the handheld electronic device 300 is shown on the display screen 322 in the same configuration as the physical keys. Using this configuration, the user can select the appropriate physical key corresponding to what is shown on the display screen 322. Thus, the desired character, command or function is obtained by depressing the physical key corresponding to the character, command or function displayed at a corresponding position on the display screen 322, rather than touching the display screen 322.

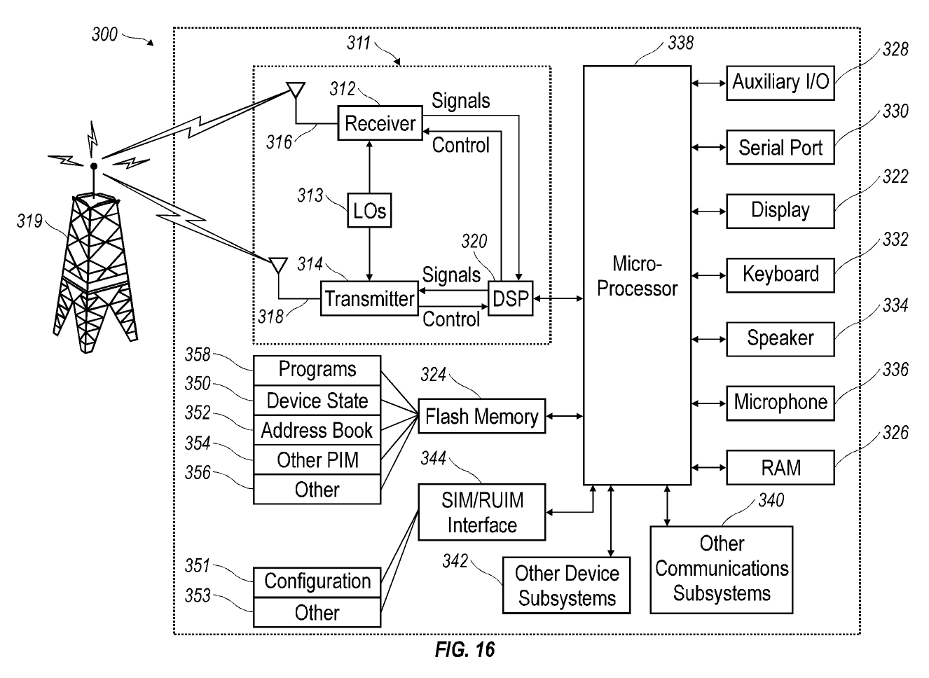

The various characters, commands and functions associated with keyboard typing in general are traditionally arranged using various conventions. The most common of these in the United States, for instance, is the QWERTY keyboard layout. Others include the QWERTZ, AZERTY, and Dvorak keyboard configurations. The QWERTY keyboard layout is the standard English-language alphabetic key arrangement 44a shown in FIG. 14. The QWERTZ keyboard layout is normally used in German-speaking regions; this alphabetic key arrangement 44b is shown in FIG. 15. The AZERTY keyboard layout 44c is normally used in French-speaking regions and is shown in FIG. 16. The Dvorak keyboard layout was designed to allow typists to type faster; this alphabetic key arrangement 44d is shown in FIG. 17.

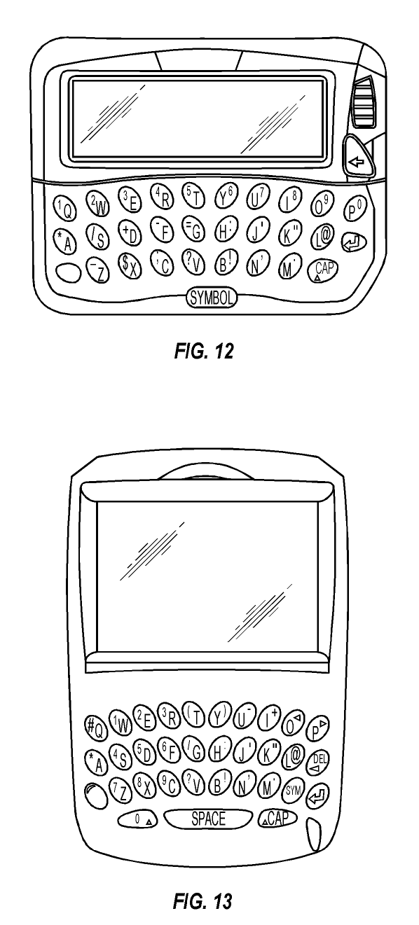

Alphabetic key arrangements are often presented along with numeric key arrangements. Typically, the numbers 1-9 and 0 are positioned in the row above the alphabetic keys 44a-d, as shown in FIGS. 14-17. Alternatively, the numbers share keys with the alphabetic characters, such as the top row of the QWERTY keyboard (see FIG. 12 for an example). Yet another exemplary numeric key arrangement is shown in FIG. 9, where a “ten-key” style numeric keypad 46 is provided on a separate set of keys that is spaced from the alphabetic/numeric key arrangement 44. The ten-key styled numeric keypad 46 includes the numbers “7”, “8”, “9” arranged in a top row, “4”, “5”, “6” arranged in a second row, “1”, “2”, “3” arranged in a third row, and “0” in a bottom row. Further, a numeric phone key arrangement 42 is exemplarily illustrated in FIG. 10.

As shown in FIG. 10, the numeric phone key arrangement 42 may also utilize a surface treatment on the surface of the center “5” key. This surface treatment is configured such that the top surface of the key is distinctive from the surface of other keys. Preferably the surface treatment is in the form of a raised bump or recessed dimple 43. Alternatively, raised bumps may be positioned on the housing around the “5” key and do not necessarily have to be positioned directly on the key.

It is desirable for handheld electronic devices 300 to include a combined text-entry keyboard and a telephony keyboard. Examples of such mobile communication devices 300 include mobile stations, cellular telephones, wireless personal digital assistants (PDAs), two-way paging devices, and others. Various keyboards are used with such devices and can be termed a full keyboard, a reduced keyboard, or phone key pad.

In embodiments of a handheld electronic device 300 having a full keyboard, the alphabetic characters are singly associated with the plurality of physical keys. Thus, in an English-language keyboard of this configuration, there are at least 26 keys in the plurality so that there is at least one key for each letter.

Devices 300 incorporating full keyboards for the alphabetic characters are shown in FIGS. 12 and 13. While both devices feature numeric keys, the device shown in FIG. 12 incorporates the numeric keys in a single row, whereas the device of FIG. 13 features numeric keys arranged according to the ITU Standard E.161 as shown in FIG. 10. The latter numeric arrangement can be described as an overlaid numeric phone keypad arrangement.

As intimated above, in order to further reduce the size of a handheld electronic device 300 without making the physical keys or software keys too small, some handheld electronic devices 300 use a reduced keyboard, where more than one character/command/function is associated with each of at least a portion of the plurality of keys. This results in certain keys being ambiguous since more than one character is represented by or associated with the key, even though only one of those characters is typically intended by the user when activating the key.

Thus, certain software usually runs on the processor of these types of handheld electronic device 300 to determine or predict what letter or word has been intended by the user. Some examples of software include predictive text routines which typically include a disambiguation engine and/or predictive editor application. The software preferably also has the ability to recognize character letter sequences that are common to the particular language, such as, in the case of English, words ending in “ing.” Such systems can also “learn” the typing style of the user making note of frequently used words to increase the predictive aspect of the software. Other types of predictive text computer programs may be utilized with the reduced keyboard arrangements described herein, without limitation. Some specific examples include the multi-tap method of character selection and “text on nine keys”.

The keys of reduced keyboards are laid out with various arrangements of characters, commands and functions associated therewith. In regards to alphabetic characters, the different keyboard layouts identified above are selectively used based on a user's preference and familiarity; for example, the QWERTY keyboard layout is most often used by English speakers who have become accustomed to the key arrangement.

FIG. 1 shows a handheld electronic device 300 that carries an example of a reduced keyboard using the QWERTY keyboard layout on a physical keyboard array of twenty keys comprising five columns and four rows. Fourteen keys are used for alphabetic characters and ten keys are used for numbers. Nine of the ten numbers share a key with alphabetic characters. The “space” key and the number “0” share the same key, which is centered on the device and centered below the remainder of the numbers on the keyboard 332. While in other embodiments, the number “0” may be located on other keys.

FIG. 14 shows an example physical keyboard array 14 of 20 keys composed of five columns and four rows. Fourteen keys on the keyboard 332 are associated with alphabetic characters and ten keys are associated with numbers. Many of the keys have different sizes than the other keys, and the rows are non-linear. In particular, the keys in the middle column 64 are wider than keys in the outer columns 60, 62, 66 and 68. To readily identify the phone user interface (the second user interface), the numeric phone keys 0-9 include a color scheme that is different from that of the remaining keys associated with the QWERTY key arrangement.

In this example, a color scheme of the numeric phone keys has a two tone appearance, with the upper portion of the numeric keys being a first color and the lower portion of the numeric keys being a second color. The first color may be lighter than the second color, or darker than the second color. Furthermore, the send key 6 and end key 8 are located on keys with alphabetic indicia have a background color and/or color of the symbols that are different from the other keys of the keyboard 332.

FIG. 15 shows a similarly formatted keyboard array 14 for the reduced QWERTY arrangement of alphabetic characters 44 as presented in FIG. 15, but the numeric phone key arrangement 42 is positioned in the first 60, second 62, and third 64 columns instead of being centered on the keyboard 332. Thus, no numerals are presented on keys in the fourth 66 and fifth 68 columns. The first row 50 of keys includes in order the following key combinations for the text entry and telephony mode: “QW/1”, “ER/2”, “TY/3”, “UI”, and “OP”. The second row 52 includes the following key combinations in order: “AS/4”, “DF/5”, “GH/6”, “JK/,”, and “L/.” The third row 54 includes the following key combinations in order: “ZX/7”, “CV/8”, “BN/9”, “M/sym” and “backspace/delete”. The fourth row 56 includes the following key combinations in order: “next/*”, “space/0”, “shift/#”, “alt” and “return/enter”. The keys in each of the rows are of uniform size and the rows and columns are straight.

Another embodiment of a reduced alphabetic keyboard is found on a standard phone keypad. Most handheld electronic devices having a phone key pad also typically include alphabetic key arrangements overlaying or coinciding with the numeric keys as shown in FIG. 11. Such alphanumeric phone keypads are used in many, if not most, traditional handheld telephony mobile communication devices such as cellular handsets.

As described above, the International Telecommunications Union (“ITU”) has established phone standards for the arrangement of alphanumeric keys. The standard phone numeric key arrangement shown in FIGS. 10 (no alphabetic letters) and 11 (with alphabetic letters) corresponds to ITU Standard E.161, entitled “Arrangement of Digits, Letters, and Symbols on Telephones and Other Devices That Can Be Used for Gaining Access to a Telephone Network.” This standard is also known as ANSI TI.703-1995/1999 and ISO/IEC 9995-8:1994. Regarding the numeric arrangement, it can be aptly described as a top-to-bottom ascending order three-by-three-over-zero pattern.

An exemplary handheld electronic device 300 and its cooperation in a wireless network 319 is exemplified in the block diagram of FIG. 16. This figure is exemplary only, and those persons skilled in the art will appreciate the additional elements and modifications necessary to make the device 300 work in particular network environments.

The block diagram of FIG. 16 representing the communication device 300 interacting in the communication network 319 shows the device's 300 inclusion of a microprocessor 338 which controls the operation of the device 300. The communication subsystem 311 performs all communication transmission and reception with the wireless network 319. The microprocessor 338 further connects with an auxiliary input/output (I/O) subsystem 328, a serial port (preferably a Universal Serial Bus port) 330, a display 322, a keyboard 332, a speaker 334, a microphone 336, random access memory (RAM) 326, and flash memory 324. Other communication subsystems 340 and other device subsystems 342 are generally indicated as connected to the microprocessor 338 as well. An example of a communication subsystem 340 is that of a short range communication subsystem such as BLUETOOTH® communication module or an infrared device and associated circuits and components. Additionally, the microprocessor 338 is able to perform operating system functions and preferably enables execution of software applications on the communication device 300.

The above described auxiliary I/O subsystem 328 can take a variety of different subsystems including the above described navigation tool. The navigation tool is preferably a trackball based device, but it can be a thumbwheel, navigation pad, or joystick. These navigation tools are preferably located on the front surface of the device 300 but may be located on an exterior surface of the device 300. Other auxiliary I/O devices can include external display devices and externally connected keyboards (not shown). While the above examples have been provided in relation to the auxiliary I/O subsystem, other subsystems capable of providing input or receiving output from the handheld electronic device 300 are considered within the scope of this disclosure. Additionally, other keys may be placed along the side of the device 300 to function as escape keys, volume control keys, scrolling keys, power switches, or user programmable keys, which may be programmed accordingly.

In an exemplary embodiment, the flash memory 324 is enabled to provide a storage location for the operating system, device programs, and data. While the operating system in a preferred embodiment is stored in flash memory 324, the operating system in other embodiments is stored in read-only memory (ROM) or similar storage element (not shown). As those skilled in the art will appreciate, the operating system, device application or parts thereof may be loaded in RAM 326 or other volatile memory.

In a preferred embodiment, the flash memory 324 contains programs/applications 358 for execution on the device 300 including an address book 352, a personal information manager (PIM) 354, and the device state 350. Furthermore, programs 358 and other information 356 including data can be segregated upon storage in the flash memory 324 of the device 300.

When the device 300 is enabled for two-way communication within the wireless communication network 319, it can send and receive signals from a mobile communication service. Examples of communication systems enabled for two-way communication include, but are not limited to, the GPRS (General Packet Radio Service) network, the UMTS (Universal Mobile Telecommunication Service) network, the EDGE (Enhanced Data for Global Evolution) network, and the CDMA (Code Division Multiple Access) network and those networks generally described as packet-switched, narrowband, data-only technologies mainly used for short burst wireless data transfer. For the systems listed above, the communication device 300 must be properly enabled to transmit and receive signals from the communication network 319. Other systems may not require such identifying information. GPRS, UMTS, and EDGE require the use of a SIM (Subscriber Identity Module) in order to allow communication with the communication network 319. Likewise, most CDMA systems require the use of a RUIM (Removable Identity Module) in order to communicate with the CDMA network. The RUIM and SIM card can be used in multiple different communication devices 300. The communication device 300 may be able to operate some features without a SIM/RUIM card, but it will not be able to communicate with the network 319. A SIM/RUIM interface 344 located within the device allows for removal or insertion of a SIM/RUIM card (not shown). The SIM/RUIM card features memory and holds key configurations 351, and other information 353 such as identification and subscriber related information. With a properly enabled communication device 300, two-way communication between the communication device 300 and communication network 319 is possible.

If the communication device 300 is enabled as described above or the communication network 319 does not require such enablement, the two-way communication enabled device 300 is able to both transmit and receive information from the communication network 319. The transfer of communication can be from the device 300 or to the device 300. In order to communicate with the communication network 319, the device 300 in a preferred embodiment is equipped with an integral or internal antenna 318 for transmitting signals to the communication network 319. Likewise the communication device 300 in the preferred embodiment is equipped with another antenna 316 for receiving communication from the communication network 319. These antennae (316, 318) in another preferred embodiment are combined into a single antenna (not shown). As one skilled in the art would appreciate, the antenna or antennae (316, 318) in another embodiment are externally mounted on the device 300.

When equipped for two-way communication, the communication device 300 features a communication subsystem 311. As is well known in the art, this communication subsystem 311 is modified so that it can support the operational needs of the device 300. The subsystem 311 includes a transmitter 314 and receiver 312 including the associated antenna or antennae (316, 318) as described above, local oscillators (LOs) 313, and a processing module 320 which in a preferred embodiment is a digital signal processor (DSP) 320.

It is contemplated that communication by the device 300 with the wireless network 319 can be any type of communication that both the wireless network 319 and device 300 are enabled to transmit, receive and process. In general, these can be classified as voice and data. Voice communication is communication in which signals for audible sounds are transmitted by the device 300 through the communication network 319. Data is all other types of communication that the device 300 is capable of performing within the constraints of the wireless network 319.

Exemplary embodiments have been described hereinabove regarding both handheld electronic devices, as well as the communication networks within which they cooperate. It should be appreciated, however, that a focus of the present disclosure is the enablement of a user of such wireless handheld electronic devices to select and edit text or characters through a touch sensitive screen, which displays an original configuration and an expanded view as needed.

What is claimed is:

1. A method for progressively displaying sequential pages on a handheld electronic device for user viewing, said method comprising:
displaying a first page of a plurality of sequentially linked pages on a display screen of a handheld electronic device;
displaying two navigation icons on the display screen of the handheld electronic device together with the first page, one of said two navigation icons signifying the previous page to the first page and acting as a user-actuable link thereto when a previous page exists and the other of said two navigation icons signifying the next page to the first page and acting as a user-actuable link thereto when a next page exists; and
scrolling toward a bottom of the first page until a lower boundary of the first page is reached and upon reaching said lower boundary, the navigation icon signifying the next page being automatically designated for user actuation.

2. The method of claim 1, further comprising actuating the designated navigation icon signifying the next page and thereby causing the next page to be displayed for user viewing.

3. The method of claim 1, further comprising affecting scrolling of the first page utilizing an auxiliary user input device on the handheld electronic device.

4. The method of claim 2, further comprising actuating the designated navigation icon signifying the next page by depressing an auxiliary user input device on the handheld electronic device.

5. The method of claim 3, wherein the auxiliary user input device is a trackball.

6. The method of claim 4, wherein the auxiliary user input device is a trackball.

7. The method of claim 1, wherein the handheld electronic device is a wireless handheld communication device that transmits data to, and receives data from a communication network utilizing radio frequency signals.

8. The method of claim 1, wherein the handheld electronic device is sized to be cradled in the palm of a user's hand.

9. The method of claim 1, wherein the handheld electronic device further comprises a keyboard suitable for accommodating textual input to the handheld electronic device and an auxiliary user input device located essentially between the keyboard and the display screen of the handheld electronic device.

10. A handheld electronic device programmed to progressively display sequential pages on a handheld electronic device for user viewing, said handheld electronic device comprising:
an auxiliary user input device;
a display screen displaying a first page of a plurality of sequentially linked pages together with two navigation icons, one of said two navigation icons signifying the previous page to the first page and acting as a user-actuable link thereto when a previous page exists and the other of said two navigation icons signifying the next page to the first page and acting as a user-actuable link thereto when a next page exists; and
a microprocessor having a control program associated therewith for controlling operation of said handheld electronic device, said control program configured to process user input requests wherein said user input requests comprise scrolling toward a bottom of the first page, using said auxiliary user input device, until a lower boundary of the first page is reached and upon reaching said lower boundary, the navigation icon signifying the next page is automatically designated for user actuation.

11. The handheld electronic device of claim 10, wherein said control program is further configured to process a request that the navigation icon signifying the next page be actuated and thereby causing the next page to be displayed for user viewing.

12. The handheld electronic device of claim 11, wherein the auxiliary user input device is depressible and depressing the auxiliary user input device requests that the navigation icon signifying the next page be actuated.

13. The handheld electronic device of claim 10, wherein the auxiliary user input device is a trackball.

14. The handheld electronic device of claim 12, wherein the auxiliary user input device is a trackball.

15. The handheld electronic device of claim 10, wherein the handheld electronic device is a wireless handheld communication device that transmits data to, and receives data from a communication network utilizing radio frequency signals.

16. The handheld electronic device of claim 10, wherein the handheld electronic device is sized to be cradled in the palm of a user's hand.

17. The handheld electronic device of claim 10, wherein the handheld electronic device further comprises a keyboard suitable for accommodating textual input to the handheld electronic device and an auxiliary user input device located essentially between the keyboard and the display screen of the handheld electronic device.

18. A processing subsystem configured to be installed in a handheld electronic device comprising a user interface including a display screen and an auxiliary user input device, said processing subsystem comprising:
operating system software that controls the operation of an incorporating handheld electronic device and said operating software is programmed to control operation of said handheld electronic device, said operating system is configured to progressively display sequential pages on a handheld electronic device for user viewing, wherein said progressively displaying sequential pages on a handheld electronic device for user viewing comprises:
displaying a first page of a plurality of sequentially linked pages on a display screen of a handheld electronic device;
displaying two navigation icons on the display screen of the handheld electronic device together with the first page, one of said two navigation icons signifying the previous page to the first page and acting as a user-actuable link thereto when a previous page exists and the other of said two navigation icons signifying the next page to the first page and acting as a user-actuable link thereto when a next page exists; and
scrolling toward a bottom of the first page until a lower boundary of the first page is reached and upon reaching said lower boundary, the navigation icon signifying the next page being automatically designated for user actuation.
